(19) United States
(12) Patent Application Publication
(10) Pub. No.: US 2004/0046991 A1
(43) Pub. Date: Mar. 11, 2004

(54) Wireless image forming apparatus and method thereof

(75) Inventor: Jin-Hyung Kim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/653,215

(22) Filed: Sep. 3, 2003

(30) Foreign Application Priority Data
Sep. 5, 2002 (KR) 2002-53625

(51) Int. Cl. G06F 15/00; B41F 1/00; H04N 1/00

(52) U.S. Cl. 358/1.15; 358/400

(57) ABSTRACT

An image forming apparatus that wirelessly transmits and receives data with an external apparatus, and has a wireless communication unit to receive image data transmitted from the external apparatus, demodulate the received image data, output the demodulated data, detect a wireless reception sensitivity of the image data, and output a reception sensitivity information corresponding to the a detection result. The apparatus also has an image forming unit varies a time-out value based on the reception sensitivity information, and stops the reception of a data from the external apparatus when during the transmission of the data from the external apparatus a period of non-reception of the data exceeds the time-out value. According to the wireless image forming apparatus, the success rate of wireless printing is improved even when communication is severed for a while due to the increase of obstacles on a communication path.

### CROSS-REFERENCE TO RELATED APPLICATIONS

This application claims the benefit of Korean Patent Application No. 2002-53625, filed Sep. 5, 2002, in the Korean Intellectual Property Office, the disclosure of which is incorporated herein by reference.

### BACKGROUND OF THE INVENTION

1. Field of the Invention

The present invention relates to a wireless image forming apparatus of a wireless printing system and a method thereof, and more particularly, to an apparatus to: vary a timeout value in accordance with the reception sensitivity of wirelessly transmitted data; and selectively stop and continue the reception of data based on the varied time-out value.

2. Description of the Related Art

A wireless printing system generally has a terminal, such as a PC, with a wireless communication unit, a wireless image forming apparatus with a wireless communication unit, and an access point to relay data input and output into and from each of the wireless communication units.

The wireless image forming apparatus of the above wireless printing system disconnects from the wireless connection when image data is not input from a device within a set-up reference time. The reference time, which is the judgment basis for wireless connection or disconnection, is also called a time-out value.

The time-out value of the wireless image forming apparatus is generally set up by an operator using a remote PC or a key input unit.

But, the set-up time-out value does not flexibly change in accordance with communication status in the above conventional wireless image forming apparatus. Therefore, when the reception sensitivity of image data is reduced due to an obstacle in the wireless communication path, a printing operation is cancelled and the printing success rate is lowered.

### SUMMARY OF THE INVENTION

It is an aspect of the present invention to provide a wireless image forming apparatus and a method thereof capable of improving the wireless printing success rate.

To accomplish the above and/or other aspects of the present invention, a wireless image forming apparatus has a wireless communication unit to output image data after receiving the image data transmitted from an external apparatus and demodulating the image data, and to output reception sensitivity information corresponding to the result of detection of the wireless reception sensitivity of the image data; and an image forming unit to change a time-out value based on the reception sensitivity information, and to stop the reception of a data from the external apparatus when a period that the data is not received does not exceed the time-out value, while the data is being transmitted from the external apparatus.

The wireless communication unit has: a wireless communication module to wirelessly receive the image data and demodulate the data, and to detect the wireless reception sensitivity of the image data and output the reception sensitivity information based on the detected wireless reception sensitivity; a storage unit to output the demodulated data after temporarily storing the data, and to store a control program for detecting the wireless reception sensitivity; and a CPU to control the communication of the data and the detection of the wireless reception sensitivity operated at the wireless communication module by loading the control program from the storage unit, and to output the reception sensitivity information input from the wireless communication module.

According to one aspect, the wireless communication module outputs the reception sensitivity information by repeatedly checking the wireless reception sensitivity of the image data for a predetermined temporal interval in accordance with a control signal of the CPU while the image data is being transmitted.

According to one aspect, the wireless image forming apparatus further comprises an input/output interface unit to convey the demodulated image data and the detected reception sensitivity information to the image forming unit, and to wirelessly transmit feedback information with respect to the printing operation after receiving the feedback information from the image forming unit.

According to one aspect, the image forming unit comprises: a storage unit to temporarily store time-out information corresponding to the reception sensitivity information input from the wireless communication unit and the demodulated image data, a controlling unit to change the time-out value in accordance with the time-out information corresponding to the reception sensitivity information stored in the storage unit, and to stop the data reception when a period that the image data is not received exceeds the time-out value, and a printing unit to print the image data based on a control signal of the controlling unit.

According to one aspect, the controlling unit uses the time-out information stored in the storage unit to determine the time out value such that the time-out value is in inverse proportion to the wireless reception sensitivity.

According to one aspect, the image forming apparatus further comprises an input/output interface unit to receive the image data and the reception sensitivity information from the wireless communication unit, and to output the feedback information with respect to the printing operation to the wireless communication unit.

A wireless printing method includes the operations of: changing a time-out value in accordance with wireless reception sensitivity of a wirelessly transmitted image data; performing printing of the transmitted image data; and stopping reception of the image data when a period of non-reception of the image data exceeds the time-out value.

According to one aspect, the changing the time-out value in accordance with wireless reception sensitivity of the wirelessly transmitted image data includes the operations of: detecting the wireless reception sensitivity of the transmitted image data for a predetermined temporal interval; reading time-out information corresponding to the detected wireless reception sensitivity; changing the time-out value in accordance with the read timeout information; and determining whether the reception and printing of the image data is complete.

According to one aspect, the wireless printing method further comprises the operations of: setting up the time-out information corresponding to the wireless reception sensitivity; and storing the set time-out information.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a structure of a wireless printing system having a wireless image forming apparatus according to an embodiment of the present invention;

FIG. 2 is a block diagram showing a structure of a wireless communication unit of FIG. 1;

FIG. 3 is a block diagram showing a structure of the image forming unit of FIG. 1; and

FIG. 4 is a flow chart showing the operation of the wireless image forming apparatus of FIG. 1.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

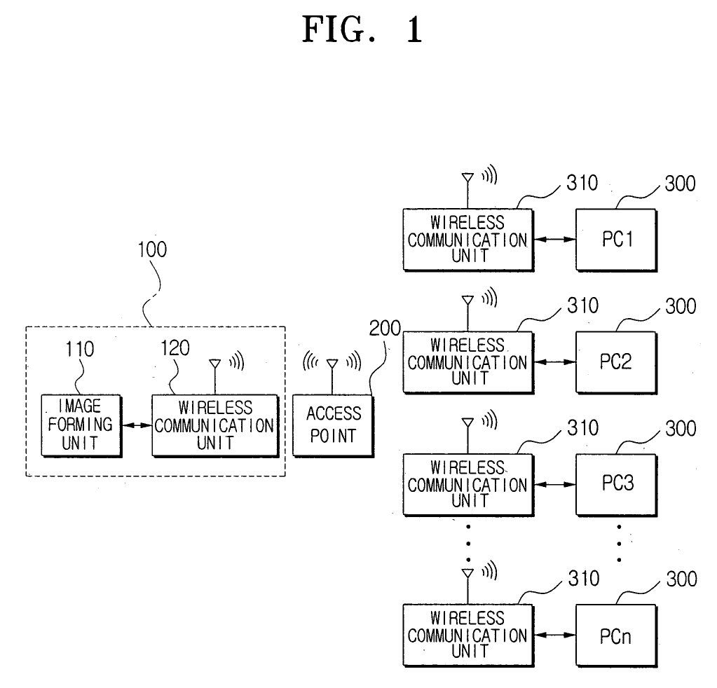

FIG. 1 is a block diagram showing a structure of a wireless printing system having a wireless image forming apparatus according to an embodiment of the present invention.

As shown in FIG. 1, the wireless printing system has: a plurality of terminals 300, such as PCs, each having a wireless communication unit 310; a wireless image forming apparatus 100 with a wireless communication unit 120 and an image forming unit 110; and an access point 200 to relay image data input from each of the wireless communication units 310 and 120.

The image data output from the plurality of PCs 300 by operators is input into the respective wireless communication units 310. The wireless communication units 310 modulate the image data output from the PCs 300, and wirelessly transmit the modulated data.

The access point 200 receives the modulated image data transmitted from the plurality of wireless communication units 310, and then relays, amplifies, and transmits the image data.

The wireless image forming apparatus 100 demodulates the modulated image data transmitted from the access point 200, and sequentially performs requested printing operations.

When a time out value is not input for a particular requested printing operation, the wireless image forming apparatus 100 cancels the particular printing operation, and performs the next sequential requested printing operation.

The wireless image forming apparatus 100 regularly detects a reception sensitivity of the image data while the data is transmitted from the access point 200, and selectively varies the time-out value based on the detected reception sensitivity.

The wireless image forming apparatus 100 has the wireless communication unit 120 to transmit and receive the image data, and the image forming unit 110 to print the image data as received.

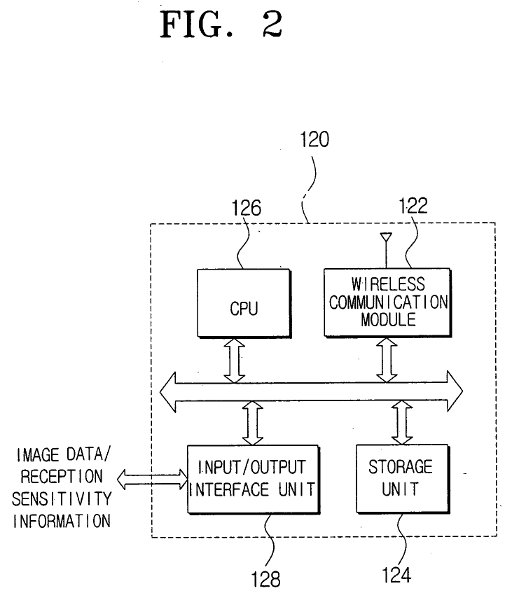

The operation of the wireless communication unit 120 will be described in greater detail by referring to FIG. 2, which is a block diagram showing the structure of the wireless communication unit 120 of FIG. 1.

As shown in FIG. 2, the wireless communication unit 120 has a wireless communication module 122, a storage unit 124, a CPU 126, and an input/output interface unit 128.

The wireless communication module 122 receives the modulated image data transmitted from the access point 200, demodulates the modulated data, and then outputs the demodulated image data to the storage unit 124. Moreover, the wireless communication module 122 regularly detects the reception sensitivity of the image data while it is being transmitted from the access point 200, and outputs reception sensitivity information based on the detected reception sensitivity to the CPU 126, in accordance with a control signal of the CPU 126.

The storage unit 124 stores a control program to detect the reception sensitivity. In addition, the storage unit 124 temporarily stores the image data transmitted from the wireless communication module 122, and outputs the data to the image forming unit 110 through the input/output interface unit 128 in accordance with the control signal of the CPU 126.

The CPU 126 controls the data communication and the reception sensitivity detection of the wireless communication module 122 by loading the control program from the storage unit 124. Furthermore, the CPU 126 outputs the reception sensitivity information, input from the wireless communication module 122, to the image forming unit 110 through the input/output interface unit 128.

The input/output interface unit 128 outputs the image data received from the storage unit 124 to the image forming unit 110. Additionally, the input/output interface unit 128 outputs the reception sensitivity information received from the CPU 126 to the image forming unit 110. Furthermore, the input/output interface unit 128 receives feedback information regarding the printing operation from the image forming unit 110, and conveys the feedback information to the wireless communication module 122 in accordance with the control signal of the CPU 126.

The image forming unit 110 selectively continues and stops the reception of the image data based on the reception sensitivity information input from the wireless communication unit 120 and the varied time out value.

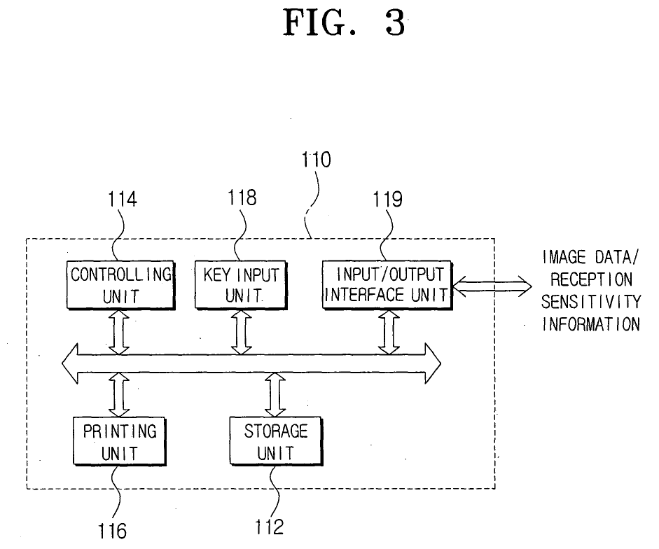

The operation of the image forming unit 110 will be described in greater detail by referring to FIG. 3, which is a block diagram showing the structure of the image forming unit 110 of FIG. 1.

As shown in FIG. 3, the image forming unit 110 has a storage unit 112, a controlling unit 114, a printing unit 116, a key input unit 118, and an input/output interface unit 119.

The input/output interface unit 119 conveys the image data and the reception sensitivity information, received from the input/output interface unit 128 of the wireless communication unit 120, to the storage unit 112 and the controlling unit 114 in accordance with a control signal of the controlling unit 114. In addition, the input/output interface unit 119 conveys feedback information regarding the printing operation of the printing unit 116 to the wireless communication unit 120 in accordance with the control signal of the controlling unit 114.

The storage unit 112 stores time-out information corresponding to the reception sensitivity information of the image data. In addition, the storage unit 112 temporarily stores the image data input from the wireless communication unit 120 and conveys the data to the printing unit 116 in accordance with the control signal of the controlling unit 114.

The controlling unit 114 receives the reception sensitivity information of the image data from the wireless communication unit 120 via the input/output interface unit 119, and reads the time-out information corresponding to the reception sensitivity information from the storage unit 112. Furthermore, the controlling unit 114 selectively varies the time-out value in accordance with the read time-out and reception sensitivity information, and stops the reception of the data when the wireless communication unit 120 does not receive the image data for a period that exceeds the varied time-out value.

That is, the controlling unit 114 controls and processes the printing of image data from the plurality of PCs 300 in a consecutive order, and when, during the transmission of the image data from one of the plurality of PCs 300, the wireless communication unit 120 does not receive the image data for a period that exceeds the varied time-out value, the controlling unit 114 stops the data reception as a time-out, and performs the printing of the next consecutive image data from one of the PCs 300.

According to one aspect, the controlling unit 114 controls the printing unit 116 to perform the printing operation with respect to the image data transmitted before the time-out. According to another aspect, the controlling unit 114 controls the printing unit 116 to not perform the printing operation with respect to the image data transmitted before the time-out.

The printing unit 116 performs the printing of the image data input from the storage unit 112 in accordance with the control signal of the controlling unit 114.

The key input unit 118 has keys for inputting various commands, including power-on, or the like, and conveys various commands to the controlling unit 114.

According to one aspect, the variation of the time-out value is in inverse proportion to the reception sensitivity information. Table 1, below, is one example of time-out value corresponding to the reception sensitivity.

TABLE 1

| Reception sensitivity information (%) | Time-out (sec) |
|---|---|
| 100˜70 | 3 |
| 69˜60 | 5 |
| 59˜55 | 8 |
| 54˜50 | 10 |
| 49˜45 | 15 |
| 44˜0 | 300 |

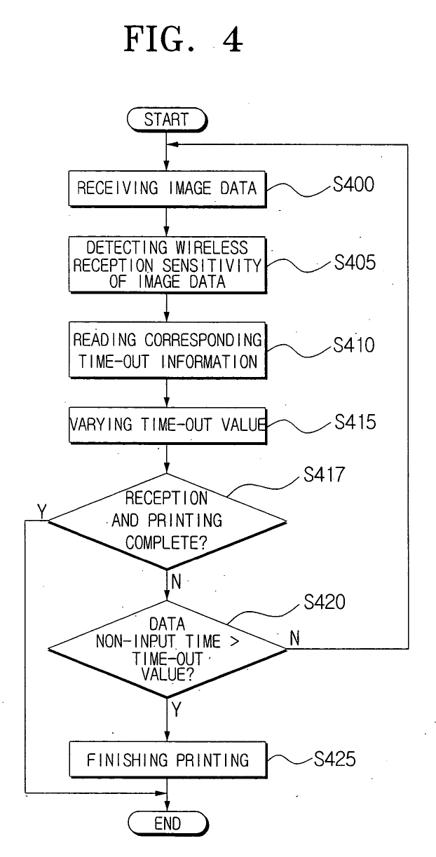

Referring to FIG. 4, a wireless printing method will be described hereinbelow. FIG. 4 is a flow chart showing a method of operation of the wireless image forming apparatus of FIG. 1.

In operation S400, wireless communication module 122 of the wireless communication unit 120 receives the modulated image data from the access point 200, and demodulates the modulated data. Then, the demodulated data is temporarily stored in the storage unit 124, and output to the image forming unit 110.

In operation S405, the wireless communication module 122 regularly detects the reception sensitivity of the image data transmitted from the access point 200, and outputs the reception sensitivity information based on the detected reception sensitivity to the image forming unit 110 in accordance with the control signal of the CPU 126.

In operation S410, the controlling unit 114 of the image forming unit 110 reads the time-out information, which corresponds to the reception sensitivity of the image data input from the wireless communication unit 120 from the storage unit 112.

In operation S415, the controlling unit 114 changes the time-out value in accordance with the read time-out information and the reception sensitivity information.

In operation S417, the controlling unit 114 determines whether the reception and printing of the image data is complete. If not, then in operation S420, the controlling unit 114 determines whether a time period since the wireless communication unit 120 last received image data exceeds the time-out value. If so, operation S425 is performed.

In operation S425, once the controlling unit 114 determines the time-out value was exceeded (in operation S420), the controlling unit 114 stops the reception of the data, and controls the printing unit 116 to cancel the printing operation.

According to one aspect, the controlling unit 114 controls the printing unit 116 to print the image data transmitted before the time-out. According to another aspect, the controlling unit 114 controls the printing unit 116 not to print the image data transmitted before the time out.

If, in operation S420, the controlling unit 114 determines that the the time-out value was not exceeded, the controlling unit 114 continues to receive image data, and goes back to operation S400.

If, in operation S417, the controlling unit 114 determines that the reception and printing of the image data is completed, then the controlling unit 114 ends the process.

According to the wireless image forming apparatus and the method of the present invention, the success rate of the wireless printing can be increased even when the reception sensitivity of data is variable.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A wireless image forming apparatus to wirelessly transmit and receive data with an external apparatus, comprising:
a wireless communication unit to
receive image data transmitted from the external apparatus, demodulate the received image data, output the demodulated image data,
detect a wireless reception sensitivity of the image data, and
output a reception sensitivity information corresponding to a result of detection; and
an image forming unit to
change a time-out value based on the reception sensitivity information, and
stop the reception of a data from the external apparatus as a time-out when a period of non-reception of the data exceeds the time-out value during the transmission of the image data from the external apparatus.

2. The wireless image forming apparatus of claim 1, wherein the wireless communication unit comprises:
a wireless communication module to
wirelessly receive the image data and demodulate the data,
detect the wireless reception sensitivity of the image data, and output the reception sensitivity information based on the detected wireless reception sensitivity;
a storage unit to temporarily store the demodulated image data and output the stored data, the storage unit storing a control program to detect the wireless reception sensitivity; and
a central processing unit to
control the communication of the data and the detection of the wireless reception sensitivity of the wireless communication module by loading the control program from the storage unit, and
output the reception sensitivity information input from the wireless communication module.

3. The wireless image forming apparatus of claim 2, wherein:
the wireless communication module outputs the reception sensitivity information by repeatedly checking the wireless reception sensitivity of the image data for a predetermined temporal interval in accordance with a control signal of the central processing unit while the image data is being transmitted.

4. The wireless image forming apparatus of claim 2, further comprising:
an input/output interface unit to
convey the demodulated image data and the detected reception sensitivity information to the image forming unit, and
receive feedback information with respect to a printing operation from the image forming unit, and then wirelessly transmit the feedback information.

5. The wireless image forming apparatus of claim 1, wherein the image forming unit performs a printing operation with respect to the image data transmitted before the timeout.

6. The wireless image forming apparatus of claim 1, wherein the image forming unit does not perform a printing operation with respect to the image data transmitted before the time-out.

7. The wireless image forming apparatus of claim 1, wherein the image forming unit comprises:
a storage unit to temporarily store time-out information corresponding to the reception sensitivity information input from the wireless communication unit and the demodulated image data;
a controlling unit to
change the time-out value in accordance with the time-out information corresponding to the reception sensitivity information stored in the storage unit, and
stop the data reception when the period of non-reception of the image data exceeds the time-out value; and
a printing unit to print the image data based on the control signal of the controlling unit.

8. The wireless image forming apparatus of claim 7, wherein:
the controlling unit uses the time-out information stored in the storage unit to determine the time out value such that the time-out value is in inverse proportion to the wireless reception sensitivity.

9. The wireless image forming apparatus of claim 7, wherein the image forming unit further comprises:
an input/output interface unit to receive the image data and the reception sensitivity information from the wireless communication unit, and to output the feedback information with respect to the printing operation to the wireless communication unit.

10. A wireless printing method comprising:
changing a time-out value in accordance with a wireless reception sensitivity of a wirelessly transmitted image data;
performing printing of the transmitted image data; and
stopping a reception of the image data when a period of non-reception of the image data exceeds the time-out value.

11. The wireless printing method of claim 10, wherein the changing the time-out value in accordance with the wireless reception sensitivity of the wirelessly transmitted image data comprises:
detecting the wireless reception sensitivity of the transmitted image data at predetermined temporal intervals;
reading time-out information corresponding to the detected wireless reception sensitivity;
varying the time-out value in accordance with the read time-out information; and
determining whether the reception and printing of the image data is complete.

12. The wireless printing method of claim 11 further comprising:
setting up the time-out information corresponding to the wireless reception sensitivity; and
storing the set time-out information.

13. The wireless printing method of claim 10, wherein the stopping the reception of the image data when the period of non-reception of the image data exceeds the time-out value further comprises:
printing with respect to the image data transmitted before the time-out.

14. The wireless printing method of claim 10, wherein the stopping the reception of the image data when the period of non-reception of the image data exceeds the time-out value further comprises:
not printing the image data transmitted before the time-out.

15. A wireless printing method comprising:
receiving image data;
detecting a wireless reception sensitivity of the image data;
selectively varying a time out value in accordance with the detected wireless reception sensitivity of the image data;
determining whether reception and printing of the image data are complete;
if reception and printing of the image data are not complete, determining whether a period of interruption of reception of the image data exceeds the varied time out value
if the period of interruption of reception of the image data exceeds the varied time out value, completing printing and ending;
if the period of interruption of reception of the image data does not exceed the varied time out value, continuing to receive image data, detecting wireless reception sensitivity of the image data, and determining whether reception and printing of the image data are complete until one of the reception and printing of the image data are complete, and the period of interruption of reception of the image data exceeds the varied time out value; and
if reception and printing of the image data are complete, ending.

16. The method according to claim 15, wherein the completing printing comprises:
printing the image data received before the time out value was exceeded.

17. The method according to claim 15, wherein the completing printing comprises:
not printing the image data received before the time out value was exceeded.

18. A wireless image forming system, comprising:
a terminal to send a printing request comprising image data;
a first wireless communication unit to receive the printing request from the terminal, and wirelessly transmit the printing request;
a wireless image forming apparatus comprising
a second wireless communication unit to wirelessly receive the printing request and detect a wireless reception sensitivity of the printing request; and
an image forming unit, in communication with the second wireless communication unit, to
form an image using the received printing request;
vary a time out value in accordance with the wireless reception sensitivity, and
stop reception of the printing request when a period of interruption of reception of the image data exceeds the varied time out value.

19. The system according to claim 18, further comprising:
an access point to relay the printing request from the first wireless communication unit to the second wireless communication unit.

20. The system according to claim 18, further comprising:
a plurality of terminals to send printing requests comprising image data; and
a plurality of first wireless communication units, each corresponding to one of the plurality of terminals, to receive printing requests from the respective terminals, and wirelessly transmit the printing requests,
wherein the second wireless communication unit wirelessly receives the printing requests from the plurality first wireless communication units, and processes the printing requests in consecutive order.
